(19) United States
(12) Patent Application Publication
(10) Pub. No.: US 2024/0190291 A1
(43) Pub. Date: Jun. 13, 2024

(54) CONTROL DEVICE FOR VEHICLE

(71) Applicant: TOYOTA JIDOSHA KABUSHIKI KAISHA, Toyota-shi Aichi-ken (JP)

(72) Inventors: Yusuke FURUHASHI, Nagoya-shi Aichi-ken (JP); Shunya KATO, Seto-shi Aichi-ken (JP)

(73) Assignee: TOYOTA JIDOSHA KABUSHIKI KAISHA, Toyota-shi Aichi-ken (JP)

(21) Appl. No.: 18/380,225

(22) Filed: Oct. 16, 2023

(30) Foreign Application Priority Data
Dec. 7, 2022 (JP) 2022-195634

(51) Int. Cl. B60L 58/13; B60L 7/18

(52) U.S. Cl. CPC B60L 58/13; B60L 7/18; B60L 2240/54

(57) ABSTRACT

A control device controls a vehicle including: a power train including a battery and an electric motor, and configured to perform regenerative traveling by using the electric motor as a generator during deceleration of the vehicle; and an auxiliary device operated by the electric power from the battery. The control device includes an electronic control unit configured to control regenerative power of the electric motor during the regenerative traveling. In a first traveling condition where a battery input limit as allowable maximum charging power of the battery becomes tight during the regenerative traveling, the electronic control unit is configured to: calculate an input limit for regeneration by adding a consumed power of the auxiliary device to the battery input limit being a negative value; and execute first regenerative power control for controlling the regenerative power so as not to exceed the input limit for regeneration.

### CROSS-REFERENCES TO RELATED APPLICATION

The present disclosure claims priority under 35 U.S.C. § 119 to Japanese Patent Application No. 2022-195634, filed on Dec. 7, 2022, which is incorporated herein by reference in its entirety.

### TECHNICAL FIELD

The present disclosure relates to a control device for a vehicle.

### BACKGROUND

JP 2013-027063 A discloses a regeneration control device for an electric vehicle. The regeneration control device monitors a state of charge (SOC) of a battery device, and calculates a regenerative current flowing through the battery device, from a map based on the SOC. Then, the regeneration control device controls regenerative torque so as not to exceed the calculated regenerative current.

### SUMMARY

In a vehicle in which regenerative power and drive power of an electric motor are controlled while charge and discharge power of a battery is limited so as not to exceed an input or output limit of the battery, it is required to reduce a change in acceleration or deceleration of the vehicle due to ON/OFF of an auxiliary device operated by electric power from the battery.

The present disclosure has been made in view of the problem described above, and an object thereof is to provide a control device for a vehicle that can reduce a change in acceleration or deceleration of the vehicle due to ON/OFF of an auxiliary device operated by electric power from a battery in a scene in which an input or output limit of the battery becomes tight.

A control device for a vehicle according to a first aspect of the present disclosure controls a vehicle including: a power train including a battery and an electric motor operated by electric power from the battery, and configured to perform regenerative traveling by using the electric motor as a generator during deceleration of the vehicle; and an auxiliary device operated by the electric power from the battery. The control device includes an electronic control unit configured to control regenerative power of the electric motor during the regenerative traveling. In a first traveling condition where a battery input limit as allowable maximum charging power of the battery becomes tight during the regenerative traveling, the electronic control unit is configured to: calculate an input limit for regeneration by adding a consumed power of the auxiliary device to the battery input limit being a negative value; and execute first regenerative power control for controlling the regenerative power so as not to exceed the input limit for regeneration.

A control device for a vehicle according to a second aspect of the present disclosure controls a vehicle including: a power train including a battery and an electric motor operated by electric power from the battery, and configured to perform power traveling by using the electric motor during acceleration of the vehicle; and an auxiliary device operated by the electric power from the battery. The control device includes an electronic control unit configured to control drive power of the electric motor during the power traveling. In a second traveling condition where a battery output limit as allowable maximum discharging power of the battery becomes tight during the power traveling, the electronic control unit is configured to: calculate an output limit for powering by subtracting a consumed power of the auxiliary device from the battery output limit being a positive value; and execute first drive power control for controlling the drive power so as not to exceed the output limit for powering.

According to the first aspect of the present disclosure, it is possible to reduce a change in the deceleration of the vehicle caused by ON/OFF of the auxiliary device operated by the electric power from the battery in a scene in which the input limit of the battery becomes tight. Also, according to the second aspect, it is possible to reduce a change in the acceleration of the vehicle caused by ON/OFF of the auxiliary device operated by the electric power from the battery in a scene in which the output limit of the battery becomes tight.

### BRIEF DESCRIPTION OF DRAWINGS

FIG. 1 is a diagram schematically showing a configuration of a vehicle according to an embodiment;

FIG. 2A is a diagram showing a basic relation R0 between maximum regenerative power, battery input limit, and auxiliary device power;

FIG. 2B is a diagram showing a relation R1 used in first regenerative power control;

FIG. 3A is a time chart used to describe an issue when the basic relation R0 is used under a first traveling condition;

FIG. 3B is a time chart used to describe an operation performed when the relation R1 is used under the first traveling condition;

FIG. 4A is a diagram showing a basic relation R0 between maximum drive power, battery output limit, and auxiliary device power;

FIG. 4B is a diagram showing a relation R1 used in first drive power control;

FIG. 5A is a time chart used to describe an issue when the basic relation R0 is used under a second traveling condition;

FIG. 5B is a time chart used to describe an operation performed when the relation R1 is used under the second traveling condition; and

FIG. 6 is a flowchart showing processing related to control of regenerative power and drive power according to the embodiment.

### DETAILED DESCRIPTION

Embodiments of the present disclosure will be described with reference to the accompanying drawings.

### 1. Configuration Example of Vehicle

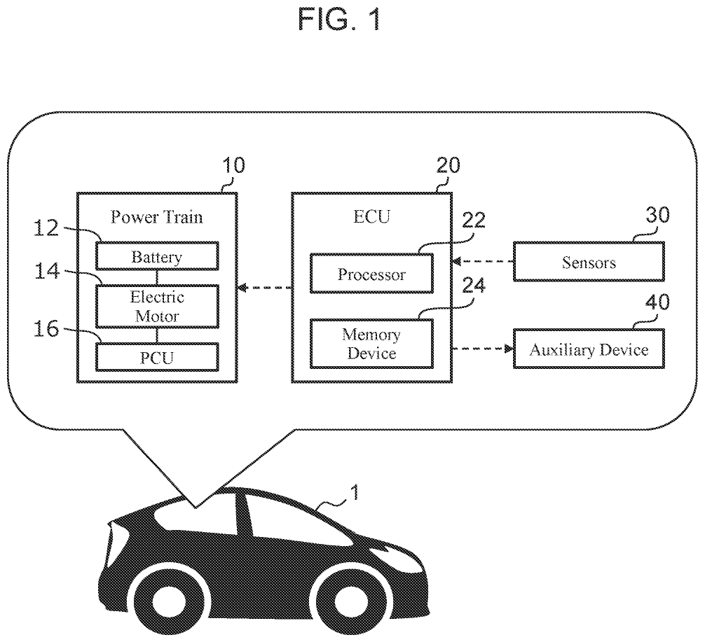

FIG. 1 is a diagram schematically showing a configuration of a vehicle 1 according to an embodiment. The vehicle 1 includes a power train 10, an electronic control unit (ECU) 20, various sensors 30, and an auxiliary device 40.

The power train 10 includes a battery 12, an electric motor 14, and a power control unit (PCU) 16. The electric motor 14 is operated by electric power from the battery 12. The PCU 16 is a power converter including an inverter for driving the electric motor 14. The PCU 16 is configured to control the electric motor 14 using the electric power of the battery 12 based on a command from the ECU 20. More specifically, the electric motor 14 generates a drive torque Tmd with the control of the PCU 16. In addition, with the control of the PCU 16, the electric motor 14 also functions as a power generator configured to generate a regenerative torque (negative torque) Tmr by being driven by the rotation of the wheels during deceleration of the vehicle 1.

According to the power train 10 described above, electric traveling (i.e., EV traveling) using the electric motor 14 can be performed. More specifically, during, for example, deceleration of the vehicle 1, regenerative traveling can be performed using the electric motor 14 as a power generator. Moreover, during, for example, acceleration of the vehicle 1, power traveling (i.e., power running) can be performed using the electric motor 14. The vehicle 1 is, for example, a battery electric vehicle (BEV). However, the “vehicle” according to the present disclosure may be any vehicle including a power train configured to perform the electric traveling, and may be, for example, a plug-in hybrid electric vehicle (PHEV).

The ECU 20 is a computer configured to control the vehicle 1 and corresponds to an example of the “control device for a vehicle” according to the present disclosure. The ECU 20 includes a processor 22 and a memory device 24. The processor 22 executes various processes. The various processes include processes related to control of drive power and regenerative power of the electric motor 14 described below. The memory device 24 stores various types of information necessary for processing by the processor 22. The processor 22 executes computer programs, whereby the various processes by the ECU 20 are realized. The computer programs are stored in the memory device 24. Alternatively, the computer programs may be recorded on a computer-readable recording medium. In addition, the ECU 20 may be configured by combining a plurality of ECUs.

The various sensors 30 include, for example, a temperature sensor configured to detect the temperature of the battery 12, an electric current sensor configured to detect the charge and discharge current of the battery 12, a vehicle speed sensor configured to detect the speed of the vehicle 1, a rotation angle sensor configured to detect the rotation angle of the electric motor 14, an accelerator pedal sensor, and a brake pedal sensor. The ECU 20 calculates a charging rate, that is, a state of charge (SOC) of the battery 12 based on the charge and discharge current detected by the electric current sensor.

The auxiliary device 40 is operated by the electric power from the battery 12. The auxiliary device 40 is, for example, an air conditioner. The air conditioner performs air conditioning (for example, cooling and heating) of the interior of the vehicle 1. Instead of the air conditioner, the “auxiliary device” according to the present disclosure may be, for example, a DC/DC converter that steps down the voltage of the battery 12 to supply electric power to a device, such as the ECU 20. Alternatively, the auxiliary device may be, for example, an alternating current (AC) power supply device that supplies electric power to a device, such as a household electrical appliance, by using the electric power from the battery 12.

### 2. Power Control of Electric Motor

First, a basic operation during the electric traveling including the regenerative traveling and the power traveling will be described. The ECU 20 calculates a required torque Treq which is a torque of the electric motor 14 (motor torque) required by the driver of the vehicle 1. The required torque Treq is calculated based on, for example, the amounts of depression of the accelerator pedal and the brake pedal and the vehicle speed. During the electric traveling, motor torque Tm corresponding to the required torque Treq calculated in this way may not always be output as it is. That is, the motor torque Tm (i.e., the regenerative torque Tmr or the drive torque Tmd) may be limited as follows.

That is, an upper limit value (i.e., an allowable maximum charging power) based on, for example, the temperature and the SOC of the battery 12 is determined for the electric power allowed to charge the battery 12 during the regenerative traveling. Hereinafter, this upper limit value is referred to as “battery input limit Winb”. Similarly, an upper limit value (i.e., an allowable maximum discharging power) based on, for example, the temperature and the SOC of the battery 12 is also determined for the electric power allowed to be discharged from the battery 12 during the power traveling. Hereinafter, this upper limit value is referred to as “battery output limit Woutb”. In addition, in this specification, the sign of the electric power is positive when the battery 12 is discharged, and is negative when the battery 12 is charged. Therefore, the battery input limit Winb is a negative value, and the battery output limit Woutb is a positive value.

The limitation of the required torque Treq based on the battery input and output limits Winb and Woutb is basically performed as follows. That is, when the electric power (motor power) Pm of the electric motor 14 according to the product of the required torque Treq and the rotation speed of the electric motor 14 (motor rotation speed) is within a range of the battery input or output limit Winb or Woutb, the ECU 20 controls the PCU 16 such that a motor torque Tm according to the required torque Treq is output from the electric motor 14. On the other hand, when the motor power Pm according to the required torque Treq exceeds the battery input or output limit Winb or Woutb, the ECU 20 controls the PCU 16 such that a motor torque Tm according to the motor power Pm limited so as not to exceed the battery input or output limit Winb or Woutb is output from the electric motor 14.

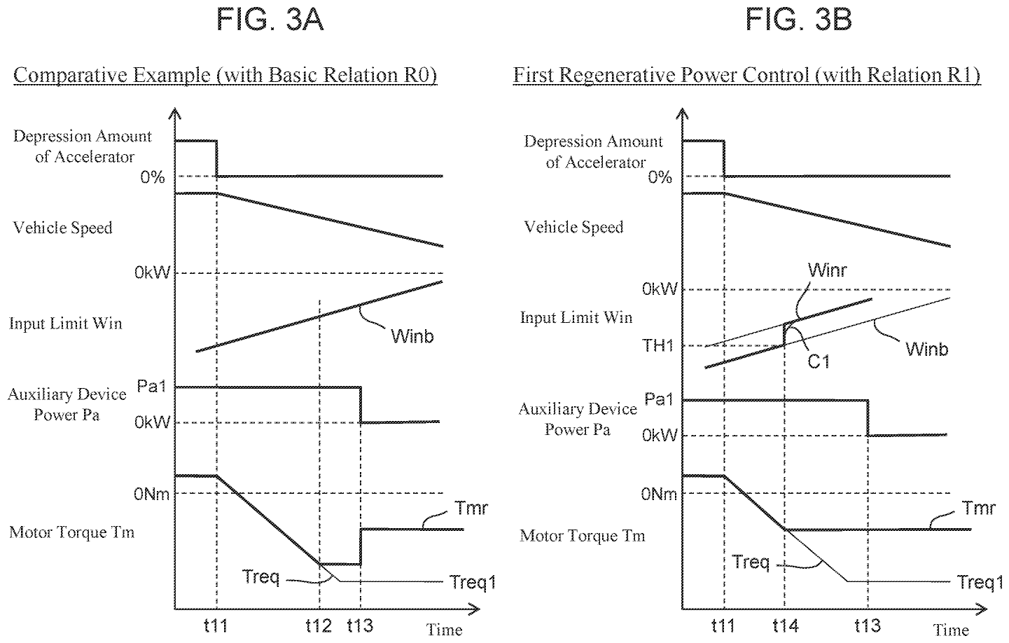

Each of the battery input and output limits Winb and Woutb is not only statically changed in accordance with the temperature and the SOC of the battery 12 as described above, but may also transiently change in a tighter direction in accordance with the traveling load during the acceleration or deceleration of the vehicle 1 as will be described below with reference to, for example, FIGS. 3A and SA. In a scene in which the battery input or output limit Winb or Woutb becomes tight as described above, it is required to reduce a change in the acceleration or deceleration of the vehicle 1 caused by ON/OFF of the auxiliary device 40 that operates with the electric power from the battery 12.

In view of the issue described above, according to the present embodiment, in a scene in which the battery input limit Winb becomes tight, the ECU 20 controls regenerative power Pmr of the electric motor 14 as follows (see Section 2-1). Also, in a scene in which the battery output limit Woutb becomes tight, the ECU 20 controls drive power Pmd of the electric motor 14 as follows (see Section 2-2). In addition, instead of the examples described below, only one of these controls of the regenerative power Pmr and the drive power Pmd may be executed.

### 2-1. Control of Regenerative Power

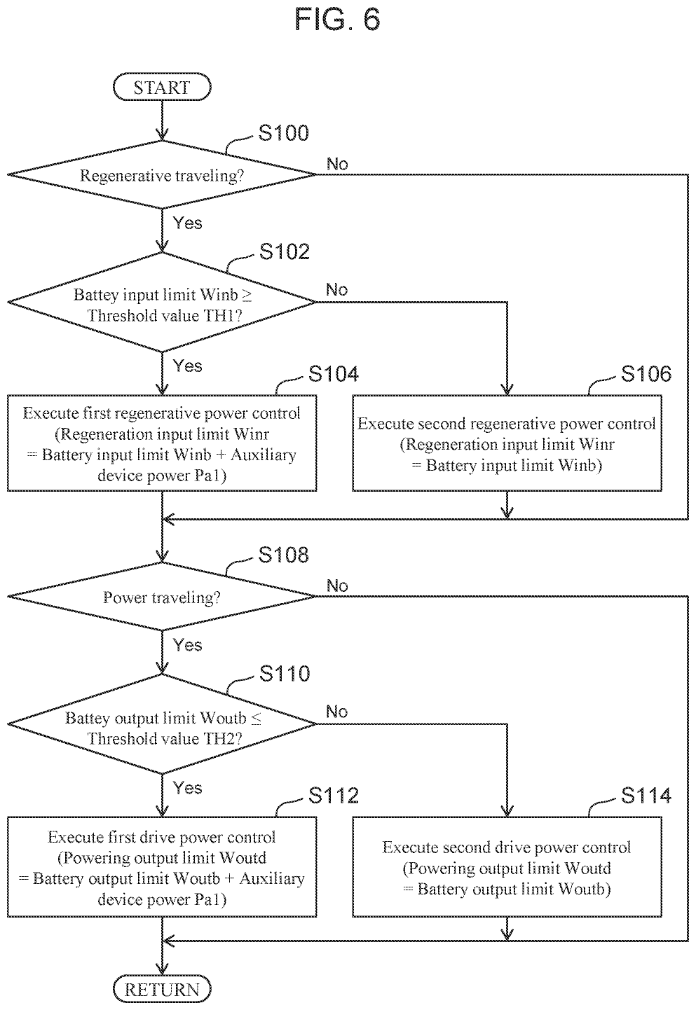

In the present embodiment, the ECU 20 executes “first regenerative power control” under a first traveling condition where the battery input limit Winb becomes tight during the regenerative traveling. As will be described below with reference to FIG. 6, whether or not the first traveling condition is satisfied is determined based on whether or not the battery input limit Winb, which is a negative value, is equal to or greater than a threshold value TH1, which is also a negative value.

In the first regenerative power control, the ECU 20 adds a value (positive value) Pa1 of power consumption (consumed power) Pa of the auxiliary device 40 to the battery input limit Winb (negative value) to calculate an “input limit Winr for regeneration (negative value)”. The input limit Winr for regeneration is also referred to as “regeneration input limit Winr”. Then, the ECU 20 controls the regenerative power Pmr of the electric motor 14 so as not to exceed the calculated regeneration input limit Winr. The power consumption Pa of the auxiliary device 40 is also simply referred to as auxiliary device power Pa.

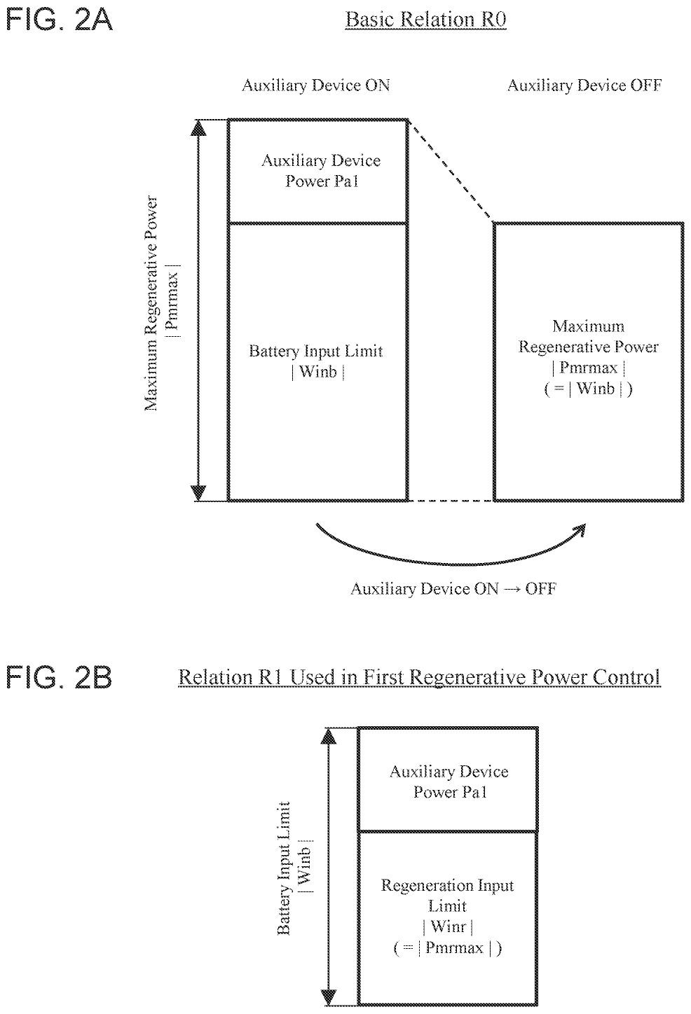

To be more specific, first, FIG. 2A is a diagram showing a basic relation R0 between the maximum regenerative power Pmrmax, the battery input limit Winb, and the auxiliary device power Pa. In the vehicle 1, the regenerative power Pmr generated during the regenerative traveling is used for charging the battery 12 and operating the auxiliary device 40. More specifically, the regenerative power Pmr is supplied to the battery 12. Also, when the auxiliary device 40 is operated, the regenerative power Pmr is supplied not only to the battery 12 but also to the auxiliary device 40. Therefore, as shown in FIG. 2A, the maximum regenerative power Pmrmax (negative value) that can be generated during the operation of the auxiliary device 40 (i.e., at the auxiliary device ON state) has an absolute value equal to the sum of the absolute value of the battery input limit Winb and the auxiliary device power Pa1. On the other hand, the maximum regenerative power Pmrmax at the time of non-operation of the auxiliary device 40 (i.e., at the auxiliary device OFF state) where the auxiliary device electric power Pa is 0 has an absolute value equal to the absolute value of the battery input limit Winb. In addition, in the present embodiment, the basic relation R0 as described above is used when it is not a scene in which the battery input limit Winb becomes tight (that is, when the first traveling condition is not satisfied) (see step S106 described below).

When the auxiliary device 40 is switched from ON to OFF when the regenerative power Pmr is the maximum regenerative power Pmrmax during the regenerative traveling, the maximum regenerative power Pmrmax is reduced by the amount of the auxiliary device power Pa1 as shown in FIG. 2A. That is, the regenerative power Pmr that can be actually generated is limited to a small value.

More specifically, FIG. 3A is a time chart used to describe an issue when the basic relation R0 is used under the first traveling condition. In FIG. 3A, the accelerator pedal is turned off by the driver at a time point t11. As a result, the vehicle speed decreases. Also, the absolute value of the battery input limit Winb decreases toward 0 with a lapse of time due to the continuation of the deceleration of the vehicle 1. That is, the battery input limit Winb changes in a tighter direction. As described above, FIG. 3A illustrates a deceleration scene in which the battery input limit Winb becomes tight. Further, the deceleration is started when the auxiliary device 40 is turned on.

The required torque Treq has a negative value in response to a deceleration request from the driver. As an example, the required torque Treq is set so as to decrease toward a negative value Treq1 with a lapse of time. The electric motor 14 is controlled so as to generate the regenerative torque Tmr as the motor torque Tm according to the required torque Treq.

A time point t12 corresponds to a time point at which the absolute value of the regenerative power Pmr according to the product of the generated regenerative torque Tmr and the motor rotation speed reaches the sum of the absolute value of the battery input limit Winb at the time point t12 and the auxiliary-device power Pa1 (i.e., the absolute value of the maximum regenerative power Pmrmax). With the passage of this time point t12, the regenerative power Pmr is limited such that regenerative power Pmr does not exceed the maximum regenerative power Pmrmax. As a result, as shown in FIG. 3A, the regenerative torque Tmr is limited with respect to the required torque Treq.

A time point t13 corresponds to a time point at which the auxiliary device 40 is switched from ON to OFF in a situation in which the regenerative torque Tmr is limited. At the time point t13, in response to the fact that the auxiliary device power Pa becomes 0, the maximum regenerative power Pmrmax rapidly decreases as shown in FIG. 2A. Then, as a result of the rapid increase in the limit amount of the regenerative power Pmr according to this rapid decrease in the maximum regenerative power Pmrmax, the regenerative torque Tmr rapidly decreases as shown in FIG. 3A. The rapid decrease in the regenerative torque Tmr as described above leads to a change in the deceleration of the vehicle 1 caused by ON/OFF of the auxiliary device 40.

On the other hand, FIG. 2B is a diagram showing a relation R1 used in the first regenerative power control. According to this relation R1, the battery input limit Winb is divided such that the absolute value of the battery input limit Winb is equal to the sum of the absolute value of the regeneration input limit Winr corresponding to the maximum regenerative power Pmrmax and the auxiliary device power Pa1. That is, the absolute value of the regeneration input limit Winr is obtained by subtracting the auxiliary device power Pa1 from the absolute value of the battery input limit Winb. Therefore, the sum of the battery input limit Winb (negative value) and the auxiliary device power Pa1 corresponds to the regeneration input limit Winr (negative value).

FIG. 3B is a time chart used to describe an operation performed when the relation R1 is used under the first traveling condition. The operation shown in FIG. 3B is exemplified for the same deceleration scene as that of FIG. 3A.

A time point t14 in FIG. 3B corresponds to a time point at which the battery input limit Winb reaches the above-described threshold value TH1 after the start of deceleration at the time point t11. When the battery input limit Winb becomes equal to or greater than the threshold value TH1 in this way, the first regenerative power control is executed. As a result, the regeneration input limit Winr (=Winb+Pa1) is calculated. In FIG. 3B, a straight line indicating the regeneration input limit Winr is additionally shown.

According to the first regenerative power control, the regenerative power Pmr is controlled (limited) so as not to exceed the regeneration input limit Winr, and as a result, the regenerative torque Tmr is limited. More specifically, at the time point t14, the input limit Win used to control (limit) the regenerative power Pmr is switched from the battery input limit Winb to the regeneration input limit Winr. In other words, the auxiliary device power Pa1 is excluded from the maximum regenerative power Pmrmax. FIG. 3B shows an example in which the regenerative power Pmr at the time point t14 is limited by the regeneration input limit Winr at the time point t14. Therefore, the regenerative torque Tmr after the time point t14 is limited as shown in FIG. 3B, for example. It should be noted that the input limit Win is returned from the regeneration input limit Winr to the battery input limit Winb when, for example, the deceleration ends.

As described above, in the present embodiment, the first regenerative power control is used in a scene (the first traveling condition) in which the battery input limit Winb becomes tight. According to the first regenerative power control, the relation R1 shown in FIG. 2B is used. That is, the regeneration input limit Winr obtained by excluding the auxiliary device power Pa1 from the battery input limit Winb is used as the maximum regenerative power Pmrmax. As a result, even if the auxiliary device 40 is switched from ON to OFF at the time point t13 (see FIG. 3B) after the start of the first regenerative power control, a change in the maximum regenerative power Pmrmax due to ON/OFF of the auxiliary device 40 does not occur. As a result, it is possible to avoid a rapid change in the regenerative torque Tmr caused by ON/OFF of the auxiliary device 40. For this reason, in a scene in which the battery input limit Winb becomes tight, it is possible to reduce a change in the deceleration of the vehicle 1 caused by ON/OFF of the auxiliary device 40.

In the example indicated by the thick solid line in FIG. 3B, the switching from the battery input limit Winb to the regeneration input limit Winr is performed in a stepwise manner at the time point t14. Instead of this example, the switching may be executed so as to gradually change the input limit Win from the battery input limit Winb toward the regeneration input limit Winr, as indicated by a curve C1 in FIG. 3B. The method of this gradual change is not particularly limited, and the gradual change may be performed using, for example, a first order lag process or a filter process that does not allow a change exceeding a designated change rate. By causing this kind of gradual change to accompany the switching of the input limit Win, the first regenerative power control can be executed while smoothing the change in the regenerative torque Tmr caused by the switching.

### 2-2. Control of Drive Power

Furthermore, in the present embodiment, the ECU 20 executes “first drive power control” under a second traveling condition where the battery output limit Woutb becomes tight during the power traveling. As will be described below with reference to FIG. 6, whether or not the second traveling condition is satisfied is determined based on whether or not the battery output limit Woutb, which is a positive value, is equal to or less than a threshold value TH2, which is also a positive value.

In the first drive power control, the ECU 20 subtracts a value (positive value) Pa1 of the auxiliary device power Pa from the battery output limit Woutb (positive value) to calculate an “output limit Woutd for powering (positive value)”. The output limit Woutd for powering is also referred to as “powering output limit Woutd”. Then, the ECU 20 controls the drive power Pmd of the electric motor 14 so as not to exceed the calculated powering output limit Woutd.

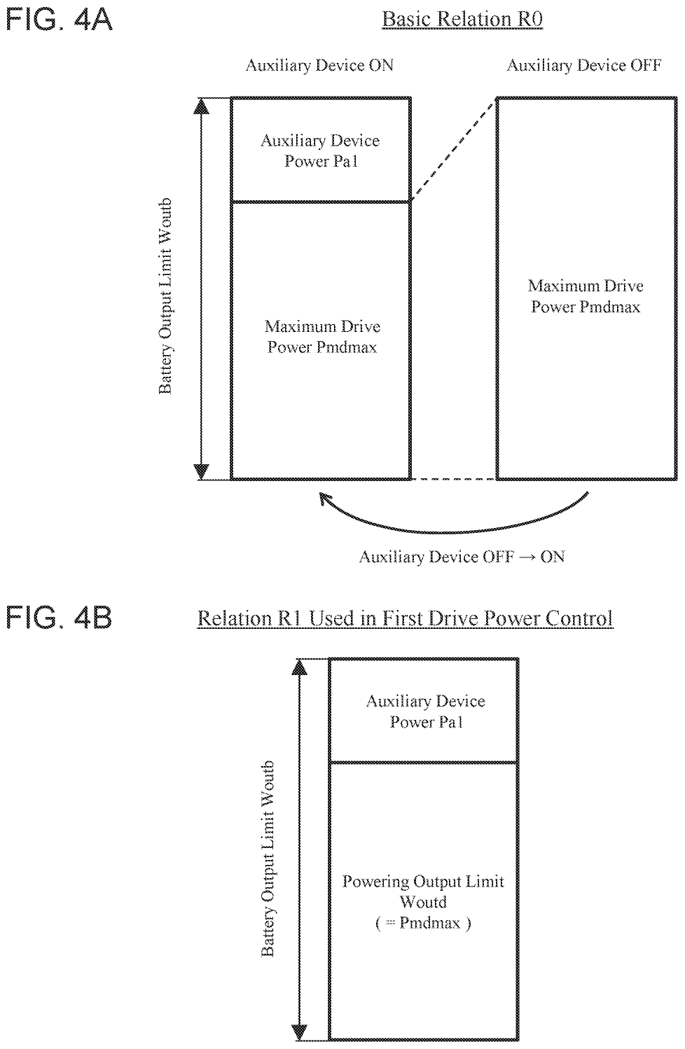

To be more specific, first, FIG. 4A is a diagram showing the basic relation R0 between the maximum drive power Pmdmax, the battery output limit Woutb, and the auxiliary device power Pa1. In the vehicle 1, the electric power charged in the battery 12 is output (discharged) for driving the electric motor 14 and operating the auxiliary device 40 during the power traveling. Therefore, as shown in FIG. 4A, the battery output limit Woutb during the operation of the auxiliary device 40 (i.e., at the auxiliary device ON state) is the sum of the maximum drive power Pmdmax that can be output and the auxiliary device power Pa1. On the other hand, when the auxiliary device 40 is not operated (i.e., at the auxiliary device OFF state), all of the battery output limit Woutb can be allocated to the drive power Pmd. Therefore, the battery output limit Woutb becomes equal to the maximum drive power Pmdmax. In the present embodiment, the basic relation R0 is used when the battery input limit Winb is not limited (that is, when the second traveling condition is not satisfied) (see step S114 described below).

When the auxiliary device 40 is switched from OFF to ON when the drive power Pmd is the maximum drive power Pmdmax during the power traveling, the maximum drive power Pmdmax is reduced by the amount of the auxiliary device power Pa1 as shown in FIG. 4A. That is, the drive power Pmd that can be actually generated is limited to a small value.

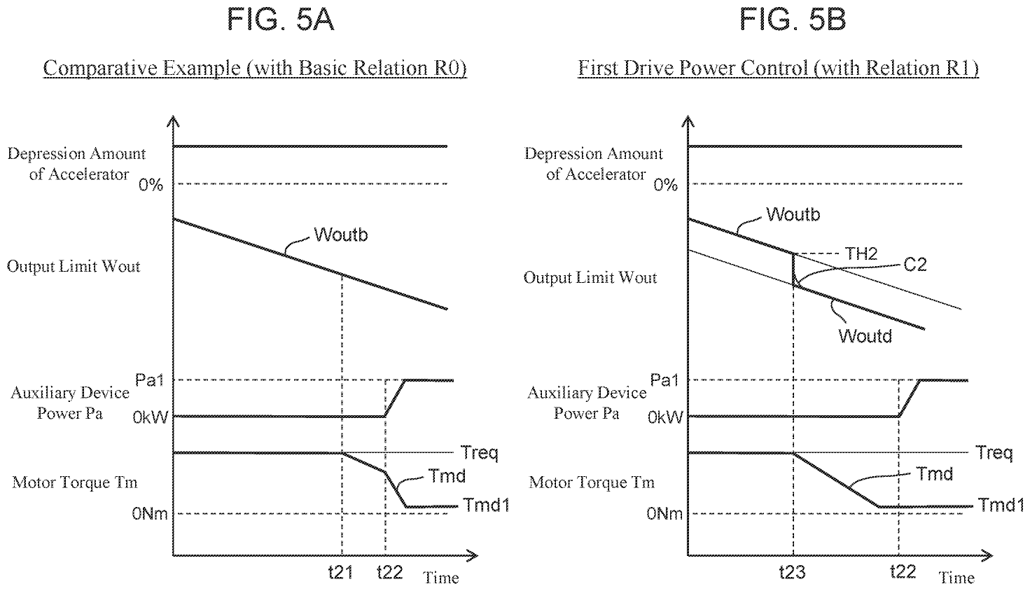

More specifically, FIG. 5A is a time chart used to describe an issue when the basic relation R0 is used under the second traveling condition. FIG. 5A illustrates a scene in which the vehicle 1 is accelerating in a state in which the depression amount of the accelerator pedal by the driver is constant. Also, the battery output limit Woutb decreases toward 0 with a lapse of time due to the continuation of the acceleration of the vehicle 1. That is, the battery output limit Woutb changes in a tighter direction. As described above, FIG. 5A illustrates an acceleration scene in which the battery output limit Woutb becomes tight. Further, the acceleration is started when the auxiliary device 40 is turned off.

The required torque Treq has a positive value in response to an acceleration request from the driver. As an example, the required torque Treq is constant in association with a constant depression amount of the accelerator pedal. The electric motor 14 is controlled so as to generate the drive torque Tmd as the motor torque Tm according to the required torque Treq.

A time point t21 corresponds to a time point at which the drive power Pmd according to the product of the generated drive torque Tmd and the motor rotation speed reaches the battery output limit Woutb at the time point t21. With the passage of this time point t21, the drive power Pmd is limited such that the drive power Pmd does not exceed the battery output limit Woutb (that is, the maximum drive power Pmdmax). As a result, as shown in FIG. 5A, the drive torque Tmd is limited with respect to the required torque Treq.

A time point t22 corresponds to a time point at which the auxiliary device 40 is switched from OFF to ON in a situation in which the drive torque Tmd is limited. After the time point t22 elapses, the maximum drive power Pmdmax rapidly decreases as shown in FIG. 4A in response to the increase of the auxiliary device power Pa to the value Pa1. Then, as a result of the rapid increase in the limit amount of the drive power Pmd in response to the rapid decrease in the maximum drive power Pmdmax, the drive torque Tmd rapidly decreases as shown in FIG. SA. The rapid decrease in the drive torque Tmd as described above leads to a change in the acceleration of the vehicle 1 caused by ON/OFF of the auxiliary device 40. In addition, in the example shown in FIG. 5A, the drive torque Tmd after the time point t22 is constant at a value Tmd1 after the rapid decrease described above.

On the other hand, FIG. 4B is a diagram showing a relation R1 used in the first drive power control. According to this relation R1, the battery output limit Woutb is divided into the powering output limit Woutd corresponding to the maximum drive power Pmdmax and the auxiliary device power Pa1. Therefore, a difference obtained by subtracting the auxiliary device power Pa1 from the battery output limit Woutb corresponds to the powering output limit Woutd.

FIG. 5B is a time chart used to describe an operation performed when the relation R1 is used under the second traveling condition. The operation shown in FIG. 5B is exemplified for the same acceleration scene as that of FIG. 5A.

A time point t23 in FIG. 5B corresponds to a time point at which the battery output limit Woutb reaches the above-described threshold value TH2 during the acceleration. When the battery output limit Woutb becomes equal to or less than the threshold value TH2 in this way, the first drive power control is executed. As a result, the powering output limit Woutd (=Woutb−Pa1) is calculated. In FIG. 5B, a straight line indicating the powering output limit Woutd is additionally shown.

According to the first drive power control, the drive power Pmd is controlled (limited) so as not to exceed the powering output limit Woutd, and as a result, the drive torque Tmd is limited. More specifically, at the time point t23, the output limit Wout used to control (limit) the drive power Pmd is switched from the battery output limit Woutb to the powering output limit Woutd. In other words, the auxiliary device power Pa1 is excluded from the battery output limit Woutb. FIG. 5B shows an example in which the drive power Pmd at the time point t23 is limited by the powering output limit Woutd at the time point t23. Therefore, the drive torque Tmd after the time point t23 is limited as shown in FIG. 5B, for example. More specifically, for example, the drive torque Tmd decreases in accordance with a decrease in the powering output limit Woutd associated with a decrease in the battery output limit Woutb over time. It should be noted that the output limit Wout is returned to the battery output limit Woutb from the powering output limit Woutd when, for example, the acceleration ends.

As described above, in the present embodiment, the first drive power control is used in a scene (the second traveling condition) in which the battery output limit Woutb becomes tight. According to the first drive power control, the relation R1 shown in FIG. 4B is used. That is, the powering output limit Woutd obtained by excluding the auxiliary device power Pa1 from the battery output limit Woutb is used as the maximum drive power Pmdmax. As a result, even if the auxiliary device 40 is switched from OFF to ON at the time point t22 (see FIG. 5B) after the start of the first drive power control, a change in the maximum drive power Pmdmax due to ON/OFF of the auxiliary device 40 does not occur. As a result, it is possible to avoid a rapid change in the drive torque Tmd caused by ON/OFF of the auxiliary device 40. For this reason, in a scene in which the battery output limit Woutb becomes tight, it is possible to reduce a change in the acceleration of the vehicle 1 caused by ON/OFF of the auxiliary device 40.

In the example indicated by the thick solid line in FIG. 5B, the switching from the battery output limit Woutb to the powering output limit Woutd is performed in a stepwise manner at the time point t23. However, similarly to the example shown in FIG. 3B regarding the control of the regenerative power Pmr, the switching may be executed so as to gradually change the power limit Wout from the battery output limit Woutb toward the powering output limit Woutd as indicated by a curve C2 in FIG. 5B. This makes it possible to perform the first drive power control while smoothing the change in the drive torque Tmd caused by the switching.

### 2-3. Processing by ECU

FIG. 6 is a flowchart showing processing related to the control of the regenerative power Pmr and the drive power Pmd according to the embodiment. The processing of this flowchart is repeatedly executed while the system of the vehicle 1 is activated.

In step S100, the ECU 20 (processor 22) determines whether or not the vehicle 1 is in the regenerative traveling. As a result, when the vehicle 1 is in the regenerative traveling (step S100; Yes), the processing proceeds to step S102. On the other hand, when the vehicle 1 is not in the regenerative traveling (step S100; No), the processing proceeds to step 108.

In step S102, the ECU 20 determines whether or not the battery input limit Winb is greater than or equal to the designated threshold value TH1. As described above, the battery input limit Winb is calculated as a value that is based on, for example, the temperature and the charging rate of the battery 12 and that changes in accordance with, for example, the traveling load during the deceleration of the vehicle 1.

When the battery input limit Winb is equal to or greater than the threshold value TH1 (step 102; Yes), the processing proceeds to step 104. In step 104, the ECU 20 executes the first regenerative power control. To be specific, the ECU 20 calculates a regeneration input limit Winr by adding the auxiliary device power Pa1 to the battery input limit Winb (negative value) calculated in step S102. Then, the ECU 20 controls the regenerative power Pmr so as not to exceed the calculated regeneration input limit Winr.

The auxiliary device power Pa1 used for the calculation in step S104 and step S112 described below is, for example, a “specification value determined in advance”. To be specific, when the auxiliary device 40 is an air conditioner, the maximum consumed power (for example, 7 kW) of the air conditioner is, for example, used as the specification value. When the auxiliary device 40 is the DC/DC converter described above, the maximum rated power of the DC/DC converter is, for example, used as the specification value. When the auxiliary device 40 is the above-described AC power supply device (for example, a power supply device of AC100V), the maximum consumed power (for example, 1.5 kW) of the AC power supply device is, for example, used as the specification value. Also, when the operation of a plurality of auxiliary devices as the auxiliary device 40 is assumed, the auxiliary device power Pa1 corresponds to the sum of the consumed powers of the plurality of auxiliary devices.

On the other hand, when the battery input limit Winb is less than the threshold value TH1 (step S102; No), the processing proceeds to step S106. In step S106, the ECU 20 executes second regenerative power control. In the second regenerative power control, the basic relation R0 shown in FIG. 2A is used. That is, the battery input limit Winb is used as it is as the input limit Win of the regenerative power Pmr. Therefore, in the second regenerative power control, the ECU 20 controls the regenerative power Pmr so as not to exceed the battery input limit Winb.

In step S108 subsequent to step S104 or S106, the ECU 20 determines whether or not the vehicle 1 is in the power traveling. As a result, when the vehicle 1 is in the power traveling (step S108; Yes), the processing proceeds to step S110. On the other hand, when the vehicle 1 is not in the power traveling (step 108; No), the processing proceeds to RETURN.

In step S110, the ECU 20 determines whether or not the battery output limit Woutb is equal to or less than the threshold value TH2. As described above, the battery output limit Woutb is calculated as a value that is determined based on, for example, the temperature and the charging rate of the battery 12 and that changes in accordance with, for example, the traveling load during the acceleration of the vehicle 1.

When the battery output limit Woutb is equal to or less than the threshold value TH2 (step S110; Yes), the processing proceeds to step S112. In step S112, the ECU 20 executes the first drive power control. To be specific, the ECU 20 calculates the powering output limit Woutd by subtracting the auxiliary device power Pa1 from the battery output limit Woutb calculated in step S110. Then, the ECU 20 controls the drive power Pmd so as not to exceed the calculated powering output limit Woutd.

On the other hand, when the battery output limit Woutb is greater than the threshold value TH2 (step S110; No), the processing proceeds to step S114. In step S114, the ECU 20 executes second drive power control. In the second drive power control, the basic relation R0 shown in FIG. 4A is used. That is, the battery output limit Woutb is used as it is as the output limit Wout of the drive power Pmd. Therefore, in the second drive power control, the ECU 20 controls the drive power Pmd so as not to exceed the battery output limit Woutb.

As described above, according to the processing shown in FIG. 6, when the battery input limit Winb is less than the threshold value TH1 (i.e., when the first traveling condition is not satisfied), the basic relation R0 shown in FIG. 2A is used. That is, the second regenerative power control is executed. As a result, in comparison with the example in which the first regenerative power control is always used during the regenerative traveling in consideration of the issue described with reference to FIG. 3A, it is possible to take measures against the rapid change while minimizing the need to limit the regenerative torque Tmr in advance in order to avoid the rapid change of the regenerative torque Tmr. This effect also applies to the example in which the second drive power control is executed when the battery output limit Woutb is greater than the threshold value TH2 (i.e., when the second traveling condition is not satisfied).

Moreover, according to the processing shown in FIG. 6, the “specification value determined in advance”, such as the maximum consumed power of the auxiliary device 40, is used as the auxiliary device power Pa1 for calculating the regeneration input limit Winr and the powering output limit Woutd. In this regard, for example, the actually consumed power of the auxiliary device 40 may be used as the auxiliary device power Pa1 instead of the specification value. However, the actually consumed power may always change during the operation of the auxiliary device 40. When the auxiliary device power Pa1 changes, the regeneration input limit Winr and the powering output limit Woutd that are calculated as described above also change. This leads to changes in the regenerative torque Tmr and the drive torque Tmd, and further, changes in the deceleration and the acceleration of the vehicle 1. On the other hand, by using the specification value (i.e., a fixed value), such as the maximum consumed power, as the auxiliary device power Pa1, it is possible to suitably take measures using the first regenerative power control and the first drive power control while avoiding a change in the acceleration or deceleration of the vehicle 1 caused by a change in the actually consumed power of the auxiliary device 40. Furthermore, since the value indicating the maximum load of the auxiliary device 40, such as the maximum consumed power, is used as the specification value, the following effects can be obtained. That is, regardless of the magnitude of the actual power of the auxiliary device 40 consumed when the auxiliary device 40 is switched from ON to OFF or from OFF to ON, the first regenerative power control and the first drive power control can be used to suitably reduce a change in the acceleration or deceleration of the vehicle 1 caused by ON/OFF of the auxiliary device 40.

1. A control device for controlling a vehicle including: a power train including a battery and an electric motor operated by electric power from the battery, and configured to perform regenerative traveling by using the electric motor as a generator during deceleration of the vehicle; and an auxiliary device operated by the electric power from the battery, the control device comprising an electronic control unit configured to control regenerative power of the electric motor during the regenerative traveling, wherein
in a first traveling condition where a battery input limit as allowable maximum charging power of the battery becomes tight during the regenerative traveling, the electronic control unit is configured to:
calculate an input limit for regeneration by adding a consumed power of the auxiliary device to the battery input limit being a negative value; and
execute first regenerative power control for controlling the regenerative power so as not to exceed the input limit for regeneration.

2. The control device according to claim 1, wherein
the electronic control unit is configured to:
when the battery input limit is equal to or greater than a first threshold value, execute the first regenerative power control; and
when the battery input limit is less than the first threshold value, execute second regenerative power control for controlling the regenerative power so as not to exceed the battery input limit.

3. The control device according to claim 1, wherein
the consumed power of the auxiliary device is a specification value determined in advance.

4. A control device for controlling a vehicle including: a power train including a battery and an electric motor operated by electric power from the battery, and configured to perform power traveling by using the electric motor during acceleration of the vehicle; and an auxiliary device operated by the electric power from the battery, the control device comprising an electronic control unit configured to control drive power of the electric motor during the power traveling, wherein
in a second traveling condition where a battery output limit as allowable maximum discharging power of the battery becomes tight during the power traveling, the electronic control unit is configured to:
calculate an output limit for powering by subtracting a consumed power of the auxiliary device from the battery output limit being a positive value; and
execute first drive power control for controlling the drive power so as not to exceed the output limit for powering.

5. The control device according to claim 4, wherein
the electronic control unit is configured to:
when the battery output limit is equal to or less than a second threshold value, execute the first drive power control; and
when the battery output limit is greater than the second threshold value, execute second drive power control for controlling the drive power so as not to exceed the battery output limit.

6. The control device according to claim 4, wherein
the consumed power of the auxiliary device is a specification value determined in advance.
